(19) United States
(12) Patent Application Publication
(10) Pub. No.: US 2011/0204744 A1
(43) Pub. Date: Aug. 25, 2011

(54) ROTOR CORE AND ELECTRIC MOTOR

(75) Inventors: Takamitsu TSUNA, Tokyo (JP); Atsushi GOTO, Tokyo (JP)

(73) Assignee: TDK CORPORATION, TOKYO (JP)

(21) Appl. No.: 13/028,584

(22) Filed: Feb. 16, 2011

(30) Foreign Application Priority Data
Feb. 25, 2010 (JP) 2010-040820

(51) Int. Cl. H02K 1/24; H02K 1/08

(52) U.S. Cl. 310/216.066

(57) ABSTRACT

A rotor core includes a body made of a soft magnetic material powder, the body being rotatable about a predetermined rotation axis; plural arms formed integral with the body from the soft magnetic material powder, the arms projecting toward an outside of the body in a diameter direction of the body and being provided with a coil; and salient poles formed integral with the arms from the soft magnetic material powder, the poles being mounted at the side of the respective arms reverse to the body.

### CROSS-REFERENCE TO RELATED APPLICATIONS

This application is based upon and claims the benefit of priority from Japanese Patent Application No. 2010-040820, filed Feb. 25, 2010, the entire contents of which are incorporated herein by reference.

### BACKGROUND OF THE INVENTION

1. Field of the Invention

The present invention relates to a rotor core used for a DC motor, and an electric motor.

2. Description of the Related Art

Compact ones of DC motors provided with a commutator and a brush are used for various purposes, such as electric components, information and communication, audio and visual, and vehicles. There has been proposed one of the DC motors described above, which includes an armature core that has a core body including plural magnetic steel plates that are stacked, and a teeth portion formed by pressing a soft magnetic powder, wherein the core body and the teeth portion can be separated from each other (Japanese Patent Publication Laid-open No. 2009-124921).

In the technique described in Japanese Patent Publication Laid-open No. 2009-124921, the core body and the teeth portion can be separated from each other. Therefore, when the armature core (rotor core) is assembled, the core body and the teeth portion have to be assembled, which takes time and labor. In the technique described in Japanese Patent Publication Laid-open No. 2009-124921, it is difficult to bring the core body and the teeth portion to be in intimate contact with each other, so that a path of a magnetic flux might be cut at the portion where the core body and the teeth portion are assembled, which might deteriorate the performance of the electric motor.

### SUMMARY OF THE INVENTION

A rotor core according to an aspect of the present invention includes a body made of a soft magnetic material powder, the body being rotatable about a predetermined rotation axis; plural arms formed integral with the body from the soft magnetic material powder, the arms projecting toward an outside of the body in a diameter direction of the body and being provided with a coil; and salient poles formed integral with the arms from the soft magnetic material powder, the poles being mounted at the side of the respective arms reverse to the body.

An electric motor according to another aspect of the present invention includes a housing; a stator held at an inner peripheral portion of the housing; the rotor core according to the present invention, the rotor core being rotatably supported to the housing so as to rotate at an inside of the stator; and a coil mounted to the respective arms of the rotor core.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a sectional view illustrating a structure of an electric motor provided with a rotor core according to an embodiment of the present invention;

FIG. 2 is a skeleton diagram illustrating the structure of the electric motor provided with the rotor core according to the embodiment of the present invention;

FIG. 3 is a perspective view illustrating the rotor core according to the embodiment of the present invention;

FIG. 4 is a front view illustrating the rotor core according to the embodiment of the present invention;

FIG. 5 is a perspective view illustrating the state in which a coil and a power transmission shaft are mounted to the rotor core according to the embodiment of the present invention;

FIG. 6 is a front view illustrating the state in which a coil and a power transmission shaft are mounted to the rotor core according to the embodiment of the present invention;

FIG. 7 is a perspective view illustrating a rotor core manufactured by stacking silicon steel plates;

FIG. 8 is a view illustrating a performance property of an electric motor using the rotor core according to the embodiment of the present invention and an electric motor using a rotor core that is manufactured by staking plural silicon steel plates;

FIG. 9 is a sectional view illustrating a modification of an arm of the rotor core according to the embodiment of the present invention;

FIG. 10 is a sectional view illustrating a modification of an arm of the rotor core according to the embodiment of the present invention;

FIG. 11 is a sectional view illustrating a modification of an arm of the rotor core according to the embodiment of the present invention;

FIG. 12 is a sectional view illustrating a modification of an arm of the rotor core according to the embodiment of the present invention;

FIG. 13 is a perspective view illustrating a rotor core according to a modification of the embodiment of the present invention;

FIG. 14 is a perspective view illustrating the state in which a coil and a power transmission shaft are mounted to the rotor core according to the modification of the embodiment of the present invention;

FIG. 15 is a front view illustrating the state in which a coil and a power transmission shaft are mounted to the rotor core according to the embodiment of the present invention;

FIG. 16 is a sectional view illustrating the state in which the coil is mounted to the rotor core according to the modification of the embodiment of the present invention;

FIG. 17 is a sectional view illustrating the state in which the coil is mounted to the rotor core according to the embodiment of the present invention;

FIG. 18 is a schematic view illustrating a path of a magnetic flux in the rotor core according to the modification of the present invention;

FIG. 19 is a schematic view illustrating the path of the magnetic flux in the rotor core manufactured by stacking the silicon steel plates;

FIG. 20 is a schematic view illustrating the path of the magnetic flux in the rotor core manufactured by stacking the silicon steel plates;

FIG. 21 is a sectional view illustrating the state in which the coil is mounted to a rotor core according to another modification of the embodiment of the present invention;

FIG. 22 is a sectional view illustrating a rotor core according to another modification of the embodiment of the present invention;

FIG. 23 is a perspective view illustrating a rotor core having salient poles that are arranged as skewed;

FIG. 24 is a plan view illustrating a rotor core having salient poles that are arranged as skewed;

FIG. 25 is a schematic view illustrating the relationship between a soft magnetic material powder and a low-melting-point lubricant agent during the warm press forming;

FIG. 26 is a schematic view illustrating the relationship between a soft magnetic material powder and a high-melting-point lubricant agent during the warm press forming according to a comparative example; and

FIG. 27 is a flowchart illustrating a manufacturing method of the rotor core.

### DETAILED DESCRIPTION OF THE PREFERRED EMBODIMENTS

Exemplary embodiments of the present invention will be described in detail with reference to the drawings. It should be noted that the present invention is not limited by the embodiments described below. The constituents in the embodiment described below include those that could easily be made by a person skilled in the art, those substantially the same, and those that are so-called equivalent. The constituents described in the embodiments below can appropriately be combined.

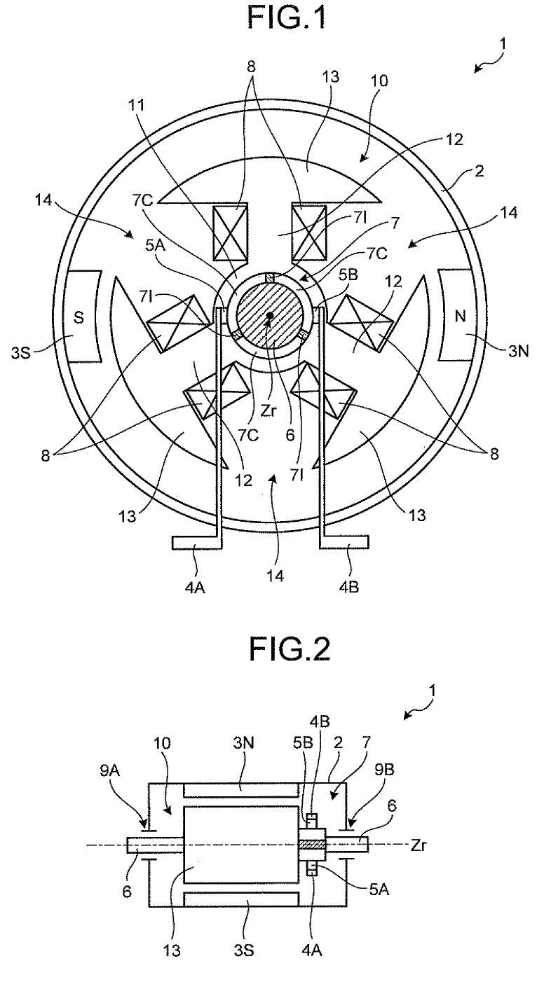

FIG. 1 is a sectional view illustrating the structure of an electric motor provided with a rotor core according to the embodiment of the present invention. FIG. 2 is a skeleton view illustrating the structure of the electric motor provided with the rotor core according to the embodiment of the present invention. An electric motor 1 illustrated in FIGS. 1 and 2 is a DC (direct current) electric motor including a commutator 7 and brushes 5A and 5B that are in contact with the commutator 7, so that it is referred to as a commutator motor. The electric motor 1 includes a housing 2, a rotor core 10, a coil 8, the commutator 7, the brushes 5A and 5B, brush holders 4A and 4B, and stators 3S and 3N. The rotor core 10, the coil 8, and the commutator 7 constitute an armature core.

The housing 2 is a structure having a cylindrical body. It supports the rotor core 10 so as to be rotatable and supports the stators 3S and 3N at its inner peripheral surface. The housing 2 is made of a magnetic body (e.g., electromagnetic soft iron, or silicon steel), and serves as a stator yoke. The stators 3S and 3N are field permanent magnets. The stator 3S is an S-pole, while the stator 3N is an N-pole. As illustrated in FIG. 2, the housing 2 has a pair of bearings 9A and 9B that supports, so as to be rotatable, a power transmission shaft 6 at two portions at both ends in the direction parallel to a rotation axis Zr of the power transmission shaft 6.

The power transmission shaft 6 is mounted to the rotor core 10. The rotor core 10 is rotatably supported by the housing 2 via the power transmission shaft 6 and the pair of bearings 9A and 9B. With this configuration, the rotor core 10 rotates with the power transmission shaft 6 about the rotation axis Zr. The rotor core 10 is provided with the commutator 7. The commutator 7 rotates with the rotor core 10 about the rotation axis Zr.

The rotor core 10 has a body 11 that can rotate about the rotation axis Zr, plural arms 12 provided at the outer periphery of the body 11, and salient poles 13 provided at the leading ends of the respective arms 12. A coil 8 is mounted to each arm 12. The space between the adjacent arms 12 is defined as a slot 14. The slot 14 is the space for accommodating the coil 8. In the present embodiment, the rotor core 10 has three arms 12, so that three coils 8 are provided to the rotor core 10. The number of the arms 12 and the coils 8 are not limited to three. The number can appropriately be changed according to the specification of the electric motor 1.

The commutator 7 is an annular structure, wherein a conductive portion 7C and an insulating portion 71 are alternately arranged in the circumferential direction. The conductive portion 7C and the insulating portion 71 are prepared in the number corresponding to the number of the coils 8. The coil 8 is electrically connected to the conductive portion 7C of the commutator 7. The brushes 5A and 5B are in contact with the surface of the commutator 7. The brushes 5A and 5B have elasticity, and they are electrically connected to the brush holders 4A and 4B, having conductivity, to be supported. The brush holders 4A and 4B press the brushes 5A and 5B to the surface of the commutator 7.

The brush holders 4A and 4B are electrically connected to a power source. The brush holders 4A and 4B feed power of the power source to the respective coils 8 through the brushes 5A and 5B and the commutator 7. Therefore, electric current flows through the magnetic field generated by the stators 3S and 3N, whereby force is generated to the coil 8, which rotates the rotor core 10. The force (rotation force) for rotating the rotor core 10 is taken out to the outside of the electric motor 1 from the power transmission shaft 6. The commutator 7 functions to change the direction of the electric current fed through the brushes 5A and 5B in order that the rotor core 10 provided with the coil 8 always rotates in the fixed direction. Next, the rotor core 10 will be described in more detail.

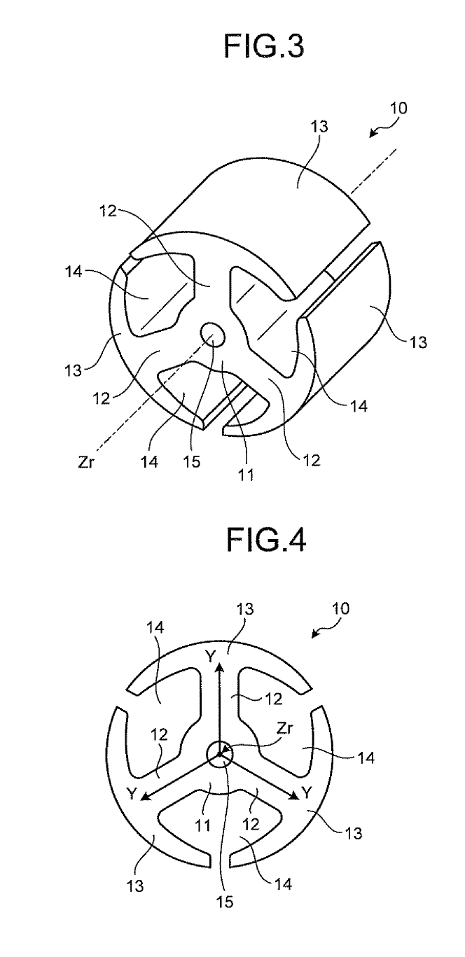

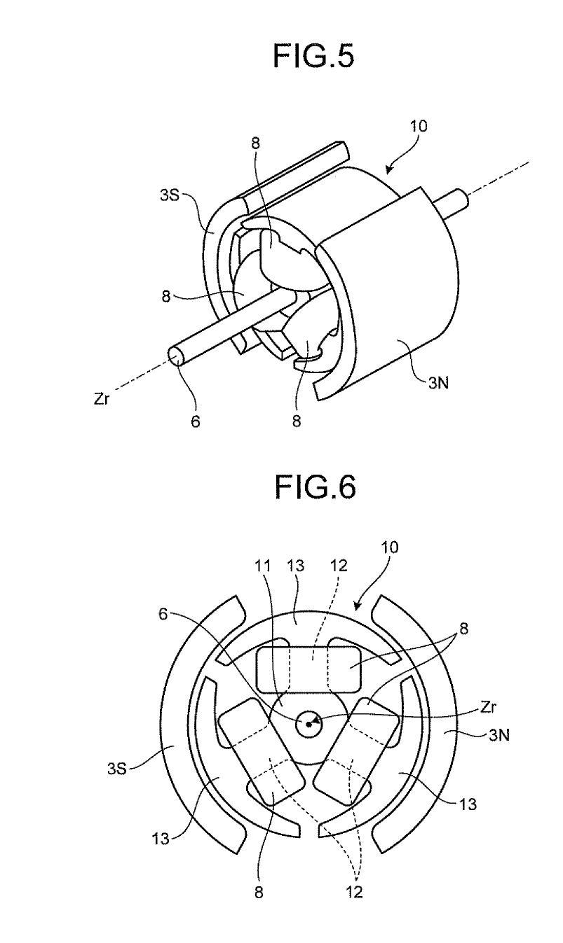

FIG. 3 is a perspective view illustrating the rotor core according to the embodiment of the present invention. FIG. 4 is a front view illustrating the rotor core according to the embodiment of the present invention. FIG. 5 is a perspective view illustrating the state in which the coil and the power transmission shaft are mounted to the rotor core according to the embodiment of the present invention. FIG. 6 is a front view illustrating the state in which the coil and the power transmission shaft are mounted to the rotor core according to the embodiment of the present invention.

As illustrated in FIGS. 3 and 4, the rotor core 10 includes the body 11, plural arms 12, and the salient poles 13. One end of each of the arms 12 is mounted to the body 11, and each of the arms 12 projects from the body 11 in the direction toward the outside in the diameter direction of the body 11, i.e., in the direction orthogonal to the rotation axis Zr and apart from the rotation axis Zr. Each of the salient poles 13 is mounted at the leading end of each of the arms 12, .e., at the side of each arm 12 reverse to the body 11.

The body 11 has a substantially cylindrical shape, but the shape of the body 11 is not limited thereto. As illustrated in FIGS. 3 and 4, the body 11 has a through-hole 15 that penetrates both ends of the body 11 in the direction of the rotation axis Zr, wherein the power transmission shaft 6 illustrated in FIG. 1 is mounted to the through-hole 15. In the present embodiment, the shape of the arm 12 cut along the plane orthogonal to the projecting direction (the direction indicated by an arrow Y in FIG. 4) is rectangle. Specifically, the arm 12 has a shape of a rectangular column, but the shape of the arm 12 is not limited thereto. The shape of the salient pole 13 cut along the plane orthogonal to the rotation axis Zr is arc, and the salient pole 13 projects from the arm 12 toward the circumferential direction of the rotor core 10. The rotor core 10, more specifically the salient poles 13, the arms 12, and the body 11, becomes the path of the magnetic flux.

As illustrated in FIG. 6, an electric wire whose surface is covered by an insulating member is wound plural times around the outer peripheral portion of each of the arms 12 to form the coil 8. As illustrated in FIG. 6, the coil 8 formed on the arm 12 is arranged between the salient pole 13 and the body 11. With this structure, the coil 8 is held by the salient pole 13, even when the rotor core 10 rotates to move the coil 8 toward the outer side in the diameter direction because of the application of centrifugal force on the coil 8. As a result, it can be prevented that the coil 8 is dropped from the rotor core 10 during the rotation of the rotor core 10. As illustrated in FIGS. 5 and 6, the rotor core 10 including the coil 8 and the power transmission shaft 6 is arranged between the stators 3S and 3N having the arc-like cross section, and rotates about the rotation axis Zr.

In the present embodiment, the body 11, the plural arms 12, and the plural salient poles 13 are respectively made of a soft magnetic material powder. In this case, the plural arms 12 are formed integral with the body 11, and the plural salient poles 13 are formed integral with the corresponding arms 12. Specifically, in the rotor core 10, the body 11, the plural arms 12, and the plural salient poles 13 are integrally formed from the soft magnetic material powder. In the present embodiment, the integral formation means that the body 11, the plural arms 12, and the plural salient poles 13 are formed integral from the same material (the same soft magnetic material powder), and does not mean that the respective components are manufactured separately, and then, they are joined integral with each other by any bonding methods or fastening methods. In the present embodiment, the body 11, the plural arms 12, and the plural salient poles 13 are formed integral with one another by press forming, i.e., by a method in which the soft magnetic material powder is filled in a forming mold, and the resultant is heated with a temperature higher than the room temperature and pressed (warm press forming), whereby the rotor core 10 is formed. The manufacturing method of the rotor core 10 is not limited to the warm press forming.

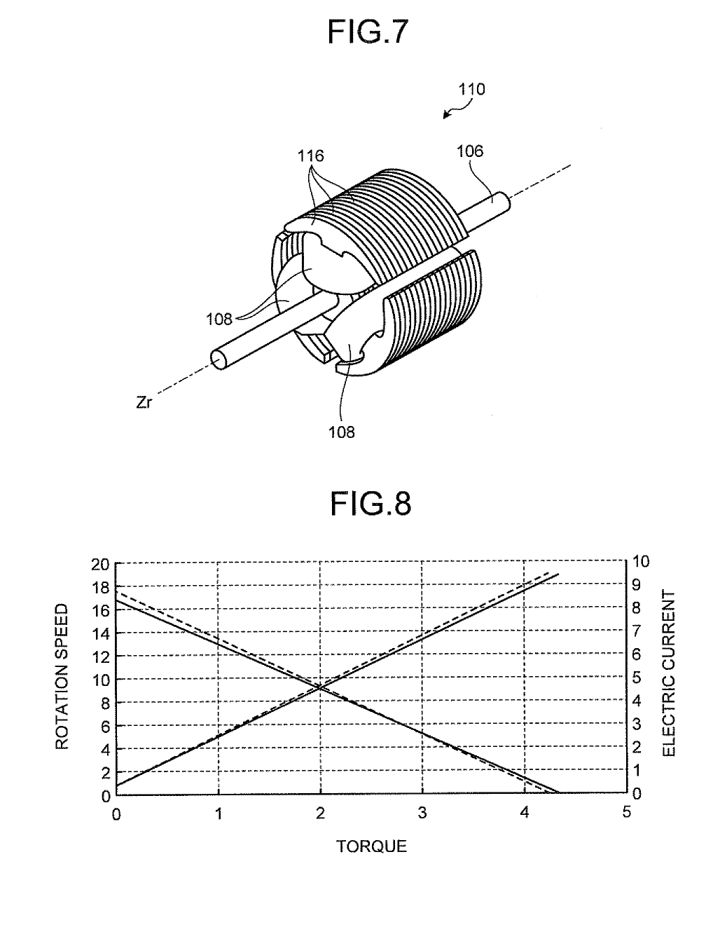

FIG. 7 is a perspective view illustrating a rotor core formed by stacking silicon steel plates. As illustrated in FIG. 7, a rotor core 110 is generally formed by stacking plural silicon steel plates 116 in the direction parallel to the rotation axis Zr. It takes time and labor for manufacturing the rotor core 110 described above, and it is difficult to form the rotor core 110 to have a complicated shape. In the present embodiment, the body 11, the plural arms 12, and the plural salient poles 13 are formed integral with one another to manufacture the rotor core 10, whereby the rotor core 10 can be manufactured by the warm press forming described above. Therefore, the rotor core 10 even having a complicated three-dimensional shape can simply and rapidly be manufactured.

Since the rotor core 10 rotates in the magnetic field, a core loss (high-frequency loss) is caused. Examples of the cause of the core loss include eddy current induced to the rotor core 10. The eddy current has strong frequency dependency. Therefore, as the frequency becomes high, the core loss is increased. In the present embodiment, the rotor core 10 is made of the soft magnetic material powder covered by the insulating member, the eddy current loss caused in the respective soft magnetic material powders can be reduced. As a result, the rotor core 10 can reduce the core loss, compared with the rotor core 110 formed by stacking plural silicon steel plates 116 illustrated in FIG. 7, whereby the performance can be enhanced. Next, the result of evaluating the performance property of the rotor core 10 will be described below in comparison with the rotor core 110 formed by stacking plural silicon steel plates 116.

FIG. 8 is a graph illustrating the performance property of the electric motor using the rotor core according to the present embodiment and the rotor core manufactured by stacking plural silicon steel plates. An abscissa axis in FIG. 8 represents a torque of the electric motor, an ordinate axis at the left side represents the rotating speed of the electric motor (rotating number or rotating angle per a unit time), and an ordinate axis at the right side represents electric current flowing through the electric motor. A downward-sloping straight line in FIG. 8 represents the relationship between the rotating speed and the torque, while an upward-sloping straight line represents the relationship between the torque and the electric current. The torque, the rotating speed, and the electric current assume a relative value with the electric motor using the rotor core formed by stacking the silicon steel plates being defined as a reference. A chain line in FIG. 8 is the result of the evaluation of the rotor core 110 formed by stacking the plural silicon steel plates 116 illustrated in FIG. 7, while a solid line represents the result of the evaluation of the rotor core 10 illustrated in FIGS. 3 to 6.

The shape and size of the rotor core 110 formed by stacking the silicon steel plates 116 and the shape and size of the rotor core 10 integrally formed from the soft magnetic material powder are the same. The coil 8 provided to the rotor core 10 illustrated in FIG. 5 and the coil 8 provided to the rotor core 110 illustrated in FIG. 7 are formed by winding an electric wire, which is made of the same material and has the same diameter, with the same turns. By virtue of this, the electric resistance of the coil 8 in the electric motor using the rotor core 10 and the electric resistance of the coil 8 in the electric motor using the rotor core 110 are the same. Upon the evaluation, a coil 108, a power transmission shaft 106, and the commutator 7 illustrated in FIG. 1 are mounted to the rotor core 10 and the rotor core 110 so as to form armature cores, and the obtained armature cores are assembled in the housing 2 illustrated in FIG. 1 to form the electric motors.

It is found from FIG. 8 that the electric motor (referred to as the electric motor A for the sake of convenience) using the rotor core 10 has the maximum torque (the torque from the rotating speed of 0) than that of the electric motor (referred to as the electric motor B for the sake of convenience) using the rotor core 110. With the same electric current, the electric motor A generates the greater torque, whereby the electric motor A can generate the torque having the same magnitude as that of the torque from the electric motor B with the reduced electric current. As described above, it can be said that the electric motor A has more excellent performance and higher energy conversion efficiency, compared with the electric motor B. Since the rotor core 10 is made of the soft magnetic material powder, the core loss of the rotor core 10 is reduced, and further, the rotor core 10 has the magnetic isotropy. Therefore, it is considered that the electric motor A has more excellent performance and higher energy conversion efficiency, compared with the electric motor B.

The maximum rotating speed is higher in the electric motor B than in the electric motor A. It can be considered that this is because the rotor core 10 has a crack when the rotor core 10 of the electric motor A is manufactured by the warm press forming. When the crack is not generated on the rotor core 10, the maximum rotating speed is equal to or higher than that of the rotor core 110, so that it is predicted the performance and the energy conversion efficiency is further enhanced.

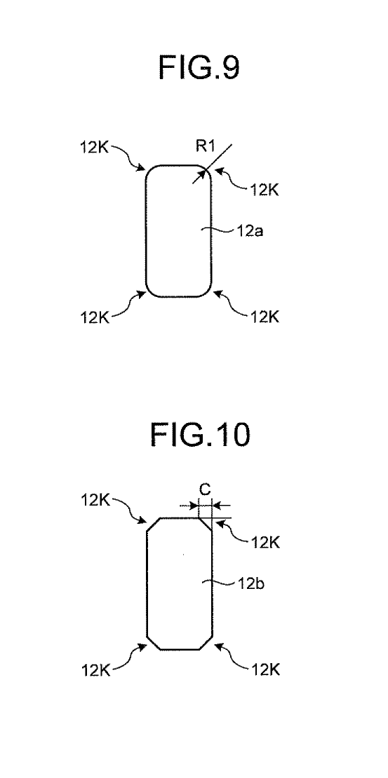

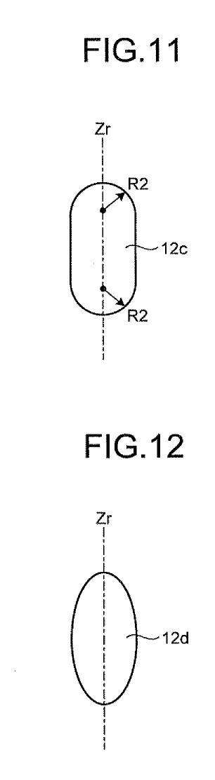

FIGS. 9 to 12 are sectional views illustrating the modifications of the arm of the rotor core according to the embodiment. In these figures, the sectional shape of the arm 12 of the rotor core 10 illustrated in FIG. 4 is illustrated as cut along plane orthogonal to the projecting direction thereof (the direction indicated by Y in FIG. 4). An arm 12a illustrated in FIG. 9 has a shape of a rectangular column (more specifically, a shape of a substantially square pole), wherein a corner portion 12K (in the present embodiment, all corner portions 12K) are formed into a circular shape having a radius R1. An arm 12b illustrated in FIG. 10 has a shape of a rectangular column (more specifically, a shape of a square pole), wherein a corner portion 12K (in the present embodiment, all corner portions 12K) are chamfered (chamfered size is C). An arm 12c illustrated in FIG. 11 has both ends, in the direction parallel to the rotating axis Zr, which are formed into a circular shape with a radius R2. An arm 12d illustrated in FIG. 12 has an elliptic sectional shape, wherein the major axis is parallel to the rotating axis Zr.

As in the arms 12a, 12c, and 12d illustrated in FIGS. 9, 11, and 12, the arm 12 of the rotor core 10 in the present embodiment may have a curved face on at least a part of the side face. This structure can considerably prevent the deterioration in the durability of the insulating member, which is caused by the electric wire sharply bent at the corner portion, when the electric wire whose surface is covered by the insulating member is wound around the arms 12a, 12c, and the like to form the coil 8. Consequently, the fear of the short-circuit, which is caused by the deterioration in the durability of the insulating member, is extremely reduced, whereby the durability and reliability of the electric motor 1 can significantly be enhanced. Since the curved surface is formed on at least a part of the side face of the arm, the sharp bending of the electric wire can be reduced, whereby the electric wire is easy to be wound along the surface of the arm. As a result, the electric wire can surely be wound around the arm, whereby the loose of the electric wire can effectively be prevented. Further, the gap between the electric wire and the arm is reduced, so that the electric wire is easy to be wound as being in intimate contact with the arm. Therefore, many electric wires can be wound around the arm for the gap. Even a thick electric wire is easy to be wound around the arm. When the corner portion 12K is chamfered as in the arm 12b illustrated in FIG. 10, the above-mentioned effect is slightly reduced, but the advantage of easy manufacture can be obtained.

The rotor core 110 formed by stacking the silicon steel plates 116 illustrated in FIG. 7 needs a process of removing burr at the corner portion, which takes time and labor for its manufacture. However, only removing the burr at the corner portion is insufficient for preventing the sharp bending of the electric wire at the corner portion. The process of forming the curved surface on at least a part of the side face of the arm or of chamfering the corner portion in order to prevent the sharp bending of the electric wire at the corner portion takes much time and labor for the manufacture, because it needs a new process after the rotor core 110 is manufactured.

In the present embodiment, the rotor core 10 is made of the soft magnetic material powder. Therefore, the rotor core 10 can easily be manufactured, even if it has the arms 12a to 12d with the complicated shape illustrated in FIGS. 9 to 12. The shape of the arm can be made more complicated. As described above, in the present embodiment, the degree of freedom in designing the rotor core 10 is increased by forming the rotor core 10 with the soft magnetic material powder, which is very suitable for pursuing the performance of the rotor core 10.

### Modification of Rotor Core

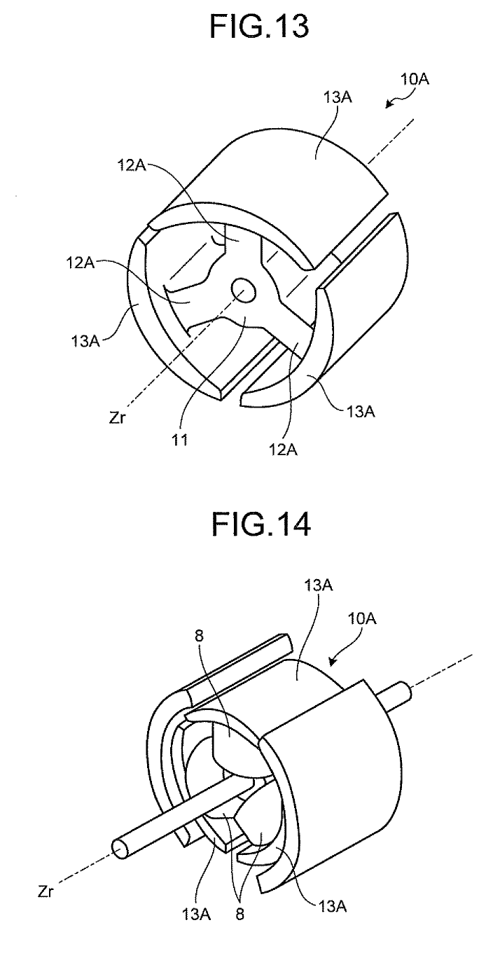

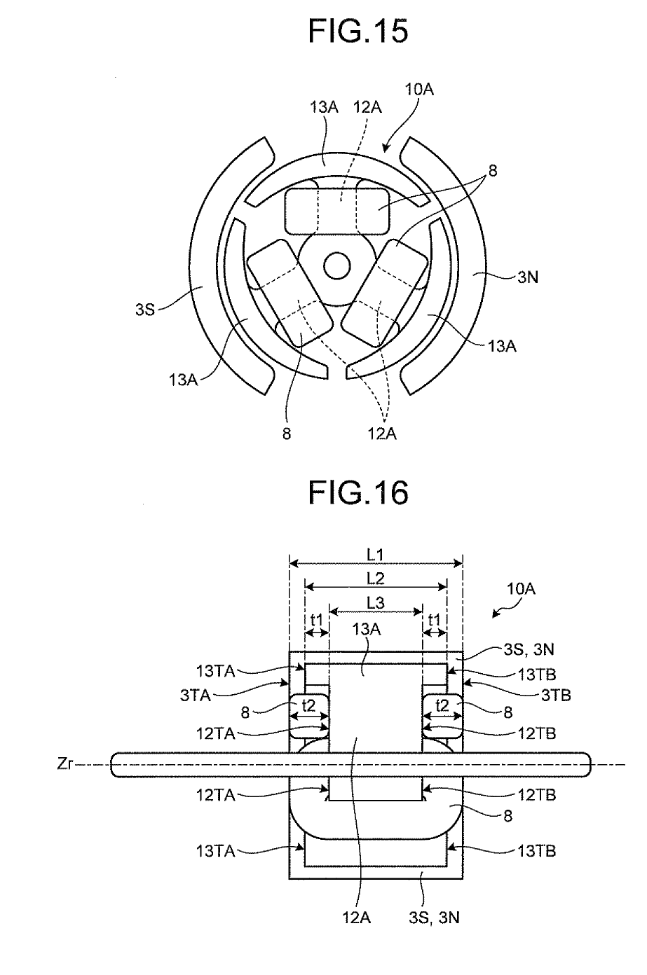

FIG. 13 is a perspective view illustrating a rotor core according to a modification of the present embodiment. FIG. 14 is a perspective view illustrating the state in which a coil and a power transmission shaft are mounted to the rotor core according to the modification of the present embodiment. FIG. 15 is a front view illustrating the state in which the coil and the power transmission shaft are mounted to the rotor core according to the modification of the present embodiment. In the description below, the size in the direction parallel to the rotation axis Zr is referred to as a rotation-axis-direction size, according to need.

A rotor core 10A illustrated in FIG. 13 is substantially similar to the rotor core 10 (see FIG. 3) described above. However, the rotor core 10A is different from the rotor core 10 in that the both ends of the arm 12A in the direction parallel to the rotation axis Zr are arranged at the inside of the rotor core 10A from both ends of the salient pole 13A in the direction parallel to the rotation axis Zr. The other configuration is the same as that of the rotor core 10.

By virtue of this structure, in the rotor core 10A, the both ends of the salient pole 13A in the direction parallel to the rotation axis Zr project from the arm 12A toward the direction parallel to the rotation axis Zr. Specifically, in the rotor core 10A, both ends of the arm 12A in the direction parallel to the rotation axis Zr are recessed from both ends of the salient poles 13A in the direction parallel to the rotation axis Zr.

As illustrated in FIGS. 14 and 15, the coil 8 is mounted to the respective arms 12A by winding the electric wire around the arms 12A. Since both ends of the arm 12A are recessed from both ends of the salient pole 13A, at least a part of the coil 8 is covered by the salient pole 13A as illustrated in FIG. 14, when the coil 8 is mounted to the rotor core 10A. By virtue of this structure, the rotation-axis-direction size of the armature core can be reduced by the amount corresponding to the portion of the coil 8 not projecting in the direction parallel to the rotation axis Zr, if the rotation-axis-direction size of the rotor core 10A is the same as that of the above-mentioned rotor core 10 (see FIG. 3). Accordingly, the electric motor 1 can be downsized.

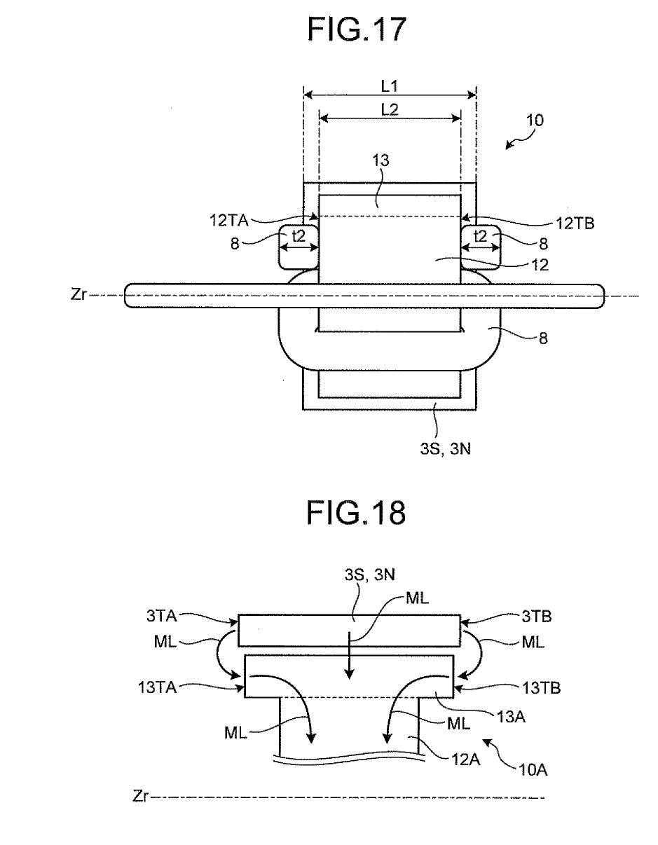

FIG. 16 is a sectional view illustrating the state in which the coil is mounted to the rotor core according to the modification of the present embodiment. FIG. 17 is a sectional view illustrating the state in which the coil is mounted to the rotor core according to the present embodiment. The rotation-axis--direction size of the stators 3S and 3N is defined as L1, the rotation-axis-direction size of the salient pole 13A is defined as L2, the rotation-axis-direction size of the arm 12A is defined as L3, and one of the protruding sizes of the salient pole 13A in the direction of the rotation axis Zr is defined as t1. The rotation-axis-direction size of the respective coils 8 at both ends 12TA and 12TB of the arm 12A in the direction of the rotation axis Zr (corresponding to the thickness of the coil 8) is defined as t2.

The size L1 is the distance between both ends 3TA and 3TB of the stators 3S and 3N in the direction of the rotation axis Zr. The size L2 is the distance between both ends 13TA and 13TB of the salient pole 13A in the direction of the rotation axis Zr, and the size L3 is the distance between both ends 12TA and 12TB of the arm 12A. Since both ends 12TA and 12TB of the arm 12A are recessed from both ends 13TA and 13TB of the salient pole 13A, one of the protruding sizes t1 of the salient pole 13A can be said to be the recessed size of one end of the arm 12A. The relationship of L2=2×t1+L3 is established among L2, L3, and t1.

In the present embodiment, an inequality of L1>L2 is established, and in the direction parallel to the rotation axis Zr, the salient pole 13A is overlapped on the whole region of the stators 3S and 3N. In the present modification, an inequality of t2 >t1 is established, and the coil 8 projects toward the direction parallel to the rotation axis Zr from both ends 13TA and 13TB of the salient pole 13 at both ends 12TA and 12TB of the arm 12A. In the present modification, an equation of L1=2×t2+L3 is established, whereby both ends 3TA and 3TB of the stators 3S and 3N and both ends of the coil 8 in the direction parallel to the rotation axis Zr are on the same position in the direction parallel to the rotation axis Zr.

FIG. 17 illustrates the case in which the rotor core 10 in the above-mentioned embodiment is used, wherein the thickness t2 of the coil 8 is equal to the thickness t2 (see FIG. 16) of the coil 8 mounted to the rotor core 10A in the present modification. The rotation-axis-direction size L1 of the stators 3S and 3N with respect to the rotor core 10 is equal to the rotation-axis-direction size L1 of the stators 3S and 3N with respect to the rotor core 10A according to the present modification. The rotation-axis-direction size L2 of the salient pole 13 in the rotor core 10 is equal to the rotation-axis-direction size L2 of the salient pole 13 in the rotor core 10A according to the present modification. In this example, an inequality of L1<2×t2+L2 is established.

In the present modification, both ends 12TA and 12TB of the arm 12A are recessed from both ends 13TA and 13TB of the salient pole 13A, so that at least a part of the coil 8 can be arranged at the recessed portion of the arm 12A. Thus, if the rotation-axis-direction size L2 of the salient pole 13A in the rotor core 10A is equal to the rotation-axis-direction size L2 of the salient pole 13 in the rotor core 10 illustrated in FIG. 17, the rotation-axis-direction size of the coil 8 mounted to the rotor core 10A can further be reduced. As a result, the electric motor having the rotor core 10A mounted thereto can be downsized according to the present modification.

Since the inequality of L1<2×t2+L2 is established in the rotor core 10 illustrated in FIG. 17, the coil 8 projects to the outside of the stators 3S and 3N in the direction parallel to the rotation axis Zr, so that the magnetic field generated by the stators 3S and 3N cannot effectively be utilized due to the projecting portion. In the rotor core 10A according to the present modification, at least a part of the coil 8 can be arranged at the recessed portion of the arm 12A because of the above-mentioned reason. Therefore, in the rotor core 10A, the whole region of the stators 3S and 3N and the whole region of the coil 8 can be agreed with each other in the direction parallel to the rotation axis Zr by establishing the inequality of L1=2×t2+L3. In this case, both ends 3TA and 3TB of the stators 3S and 3N and both ends of the coil 8 in the direction parallel to the rotation axis Zr are on the same position in the direction parallel to the rotation axis Zr.

By virtue of this structure, when the size of L2 in the rotor core 10A is the same as that in the rotor core 10, and the stators 3S and 3N having the same L1 are used, the rotor core 10A can prevent the coil 8 from projecting to the outside of the stators 3S and 3N in the direction parallel to the rotation axis Zr, compared with the rotor core 10. As a result, the magnetic field generated by the stators 3S and 3N can effectively be utilized by using the rotor core 10A. Accordingly, even when the stators 3S and 3N that are the same as those in the rotor core 10 are used, the rotor core 10A can further enhance the performance of the electric motor. When the rotor core 10A is used, the coil 8 is accommodated within the rotation-axis-direction size L1 of the stators 3S and 3N, whereby the rotation-axis-direction size of the electric motor can also be reduced. The weight of the rotor core 10A can be reduced, since both ends 12TA and 12TB of the arm 12A are recessed. Therefore, the electric motor using the rotor core 10A starts the rotation with low current, torque is increased, and further, the inertia moment is decreased, whereby it has advantages of being easy to accelerate or decelerate, and being easy to be controlled. According to the evaluation by the simulation, the rotor core 10A generates the maximum torque greater than that of the rotor core 10, generates the torque of the same magnitude with the more reduced current, and provides the enhanced energy conversion efficiency.

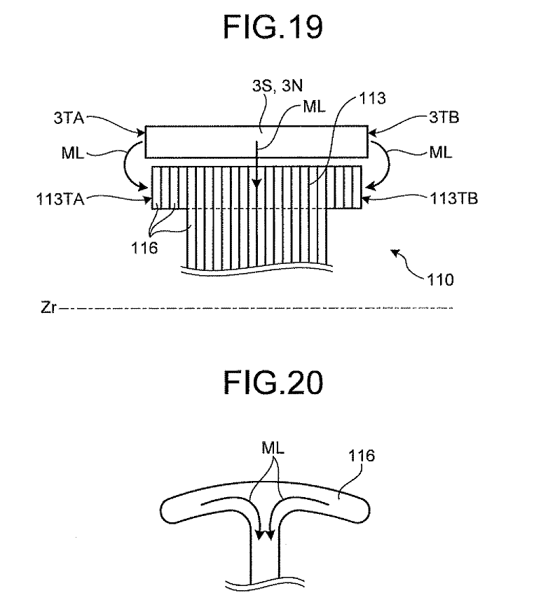

FIG. 18 is a schematic view illustrating the path of the magnetic flux in the rotor core according to the present modification. FIGS. 19 and 20 are schematic views illustrating the path of the magnetic flux in the rotor core formed by stacking the silicon steel plates. When both ends 13TA and 13TB of the salient pole 13A project toward the direction parallel to the rotation axis Zr, the rotation-axis-direction size of the armature core can be reduced with the coil 8 being mounted to the rotor core 10A. As illustrated in FIG. 19, the plural silicon steel plates 116 are stacked, and ends 113TA and 113TB of a salient pole 113 can be allowed to project toward the direction parallel to the rotation axis Zr. However, this structure needs to stack the silicon steel plates 116 having the different shape, which takes time and labor for its manufacture. Since the projecting portion has small bonding area, the bonding strength might be reduced.

In the present modification, the rotor core 10A is made by using the soft magnetic material powder as in the above-mentioned embodiment. Therefore, the complicated three-dimensional shape, such as the formation of the recessed portion at both ends 12TA and 12TB of the arm 12A and the formation of the projecting portion, greatly projecting toward the direction parallel to the rotation axis Zr, of both ends 13TA and 13TB of the salient pole 13A, can easily be realized. The projecting portion of the rotor core 10A is formed integral with the non-projecting portion of the arm 12A and the salient pole 13A, so that the strength can be secured.

When both ends 13TA and 13TB of the salient pole 13A project toward the direction parallel to the rotation axis Zr, the magnetic flux generated by the stators 3S and 3N can efficiently be directed into the rotor core 10A through the salient pole 13A. Therefore, the performance of the electric motor can be enhanced. In this case, the magnetic flux ML from both ends 3TA and 3TB of the stators 3S and 3N enters the salient pole 13A from both ends 13TA and 13TB.

The rotor core 10A, including the salient pole 13A, is integrally formed by using the soft magnetic material powder. Therefore, the rotor core 10A has the magnetic isotropy, whereby the magnetic flux ML entering the salient pole 13A from both ends 13TA and 13TB passes through the inside of the salient pole 13A and the arm 12A, and then, passes through the rotor core 10A. As described above, in the present modification, the rotor core 10A is integrally formed by using the soft magnetic material powder, whereby the path of the magnetic flux can surely be formed in the rotor core 10A. As a result, the magnetic flux in the rotor core 10A can effectively be utilized.

On the other hand, in the silicon steel plate 116 of the rotor core 110 illustrated in FIG. 19, the magnetic flux is easy to pass in the direction parallel to the plate surface (in the direction indicated by an arrow in FIG. 20), but the magnetic flux is difficult to pass in the direction orthogonal to the plate surface. As described above, the silicon steel plate 116 has a magnetic anisotropy. Therefore, even if the magnetic flux ML of the stators 3S and 3N enters from both ends 113TA and 113TB of the salient pole 113, the magnetic flux ML is hardly transmitted in the direction perpendicular to the plate surface of the silicon steel plate 116, i.e., in the direction parallel to the rotation axis Zr. As a result, the rotor core 110 cannot effectively utilize the magnetic flux ML entering from both ends 113TA and 113TB of the salient pole 113. When the silicon steel plates are stacked, it is difficult to allow the adjacent silicon steel plates to be in intimate contact with each other, so that the path of the magnetic flux is cut at this portion.

As described above, the rotor core 10A according to the present modification has the magnetic isotropy, so that the magnetic flux ML entering the salient pole 13A from both ends 13TA and 13TB can also pass through the rotor core 10A. Since the rotor core 10A is made by integrally forming the soft magnetic material powder, the magnetic property is uniform all over the rotor core 10A, resulting in that the magnetic flux is easy to pass through the inside thereof. As a result, the rotor core 10A can effectively utilize the magnetic flux, with the result that the performance of the electric motor using the rotor core 10A is enhanced.

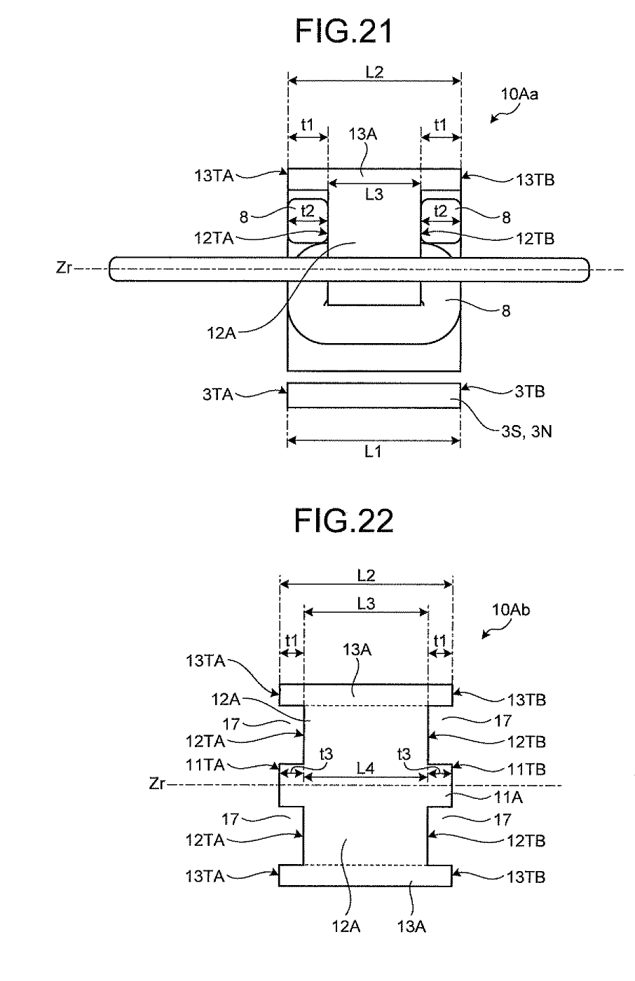

FIG. 21 is a sectional view illustrating the state in which a coil is mounted to a rotor core according to another modification of the embodiment. The rotor core 10Aa is substantially the same as the rotor core 10A illustrated in FIG. 16, but the points described below are different. Specifically, one of the projecting sizes t1 of the salient pole 13A is set to be not less than the thickness t2 of the coil 8 (t1≧t2), and the rotation-axis-direction size L2 of the salient pole 13A is set to be equal to the rotation-axis-direction size L1 of the stators 3S and 3N.

By virtue of this structure, the ends 12TA and 12TB of the arm 12A are recessed from the respective ends 13TA and 13TB of the salient pole 13A by the amount corresponding to the thickness t2 of the coil 8, which is mounted to the arm 12A, or more. Consequently, the coil 8 can be arranged in the region of the salient pole 13A in the direction parallel to the rotation axis Zr. The ends 3TA and 3TB of the stators 3S and 3N and both ends 13TA and 13TB of the salient pole 13A are located at the same position in the direction parallel to the rotation axis Zr. Thus, the magnetic flux generated by the stators 3S and 3N can more efficiently be directed to pass into the rotor core 10Aa through the salient pole 13A, whereby the performance of the electric motor can be enhanced.

FIG. 22 is a sectional view illustrating a rotor core according to still another modification of the present embodiment. In the rotor core 10Ab, both ends 11TA and 11TB of a body 11A in the direction parallel to the rotation axis Zr project toward the outside of the rotor core 10Ab in the direction parallel to the rotation axis Zr. By virtue of this structure, both ends 12TA and 12TB of the arm 12A are recessed from both ends 13TA and 13TB of the salient pole 13A and the both ends 11TA and 11TB of the body 11A. The recessed portion is defined as a recessed portion 17.

The rotation-axis-direction size of the body 11A (the distance between both ends 11TA and 11TB in the direction parallel to the rotation axis Zr) is defined as L4, one of the projecting sizes of the salient pole 13A in the direction of the rotation axis Zr (the distance between both ends 12TA and 12TB of the arm 12A and the ends 11TA and 11TB of the body 11A) is defined as t3. In this example, the rotation-axis-direction size L3 of the arm 12A and the rotation-axis-direction size L4 of the body 11A are made equal to each other, and the equation of t1=t3 is established. Therefore, the equation of 2×t1+L2=2×t3×L3 is established, which indicates that the respective ends 11TA and 11TB of the body 11A and the respective ends 13TA and 13TB of the salient pole 13A are present on the same plane (the plane is flat).

In the rotor core 10Ab, the respective ends 11TA and 11TB of the body 11A project from the respective ends 12TA and 12TB of the arm 12A toward the direction parallel to the rotation axis Zr, and the recessed portion 17 is formed, whereby the coil 8 illustrated in FIG. 21 and other figures can be accommodated in the recessed portion 17. Specifically, the coil 8 is restricted by the respective ends 11TA and 11TB of the body 11A and the respective ends 13TA and 13TB of the salient pole 13A, whereby the positioning precision in the diameter direction of the rotor core 10Ab is enhanced. Accordingly, the rotation balance of the rotor core 10Ab is enhanced, whereby vibration or noise caused by the electric motor using the rotor core 10Ab is suppressed.

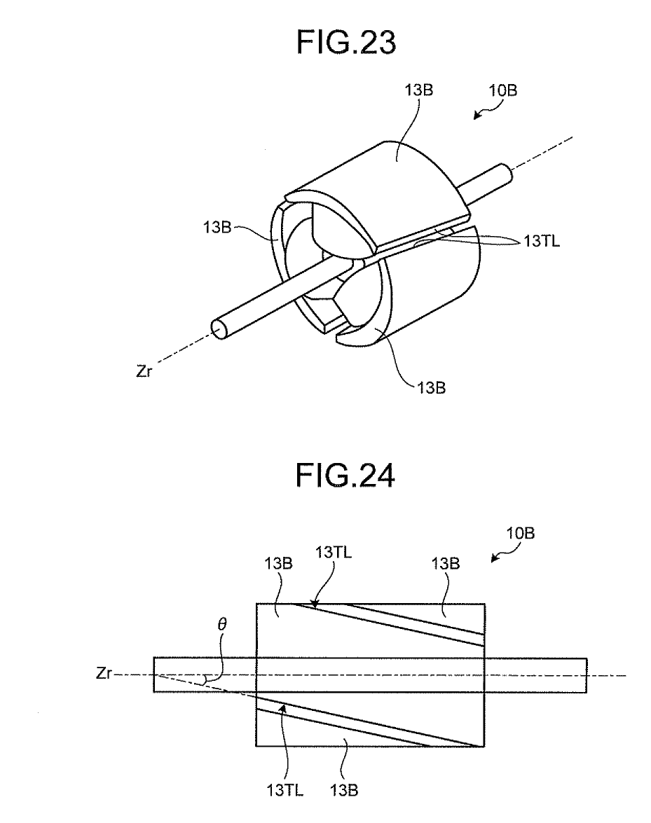

FIG. 23 is a perspective view illustrating a rotor core mounted such that the salient pole is skewed. FIG. 24 is a plan view illustrating the rotor core mounted such that the salient pole is skewed. In order to reduce cogging, a salient pole 13B is skewed (obliquely positioned) as in the rotor core 103 illustrated in FIGS. 23 and 24. In this case, the side ends 13TL in the circumferential direction of the adjacent salient poles 13B are arranged so as to be parallel to each other, and are tilted with a predetermined angle θ with respect to the rotation axis Zr as viewed in a plane as illustrated in FIG. 24.

The skewed arrangement of the salient pole 13B is effective for reducing the cogging. However, when a rotor core formed by stacking plural silicon steel plates is produced, it is necessary to make integration such that the stacked silicon steel plates are gradually shifted in the circumferential direction. Therefore, it takes time and labor to manufacture the rotor core by stacking the silicon steel plates, and further, it is difficult to secure the dimensional precision.

The rotor core 10B is integrally formed by the warm press forming after the soft magnetic material powder is filled in a forming mold, for example. Therefore, even a complicated shape in which the salient pole 13B is skewed can easily be formed. Accordingly, even if a complicated shape is employed in order to improve the cogging, the rotor core can relatively easily be manufactured. Next, the soft magnetic material powder constituting the rotor cores 10, 10A, 10Aa, 10Ab, and 10B will be described. Soft magnetic material powder constituting rotor core

The rotor cores 10, 10A, 10Aa, 10Ab, and 10B (hereinafter referred to as rotor cores 10) are manufactured in such a manner that at least a low-melting-point lubricant agent is added to the soft magnetic material powder, and then, a warm press forming in which the soft magnetic material powder to which the low-melting-point lubricant agent is added is heated to have a temperature higher than the room temperature and pressed is carried out in order to form the resultant into an optional shape. Specifically, the rotor cores 10 according to the present embodiment contain the soft magnetic material powder and the low-melting-point lubricant agent.

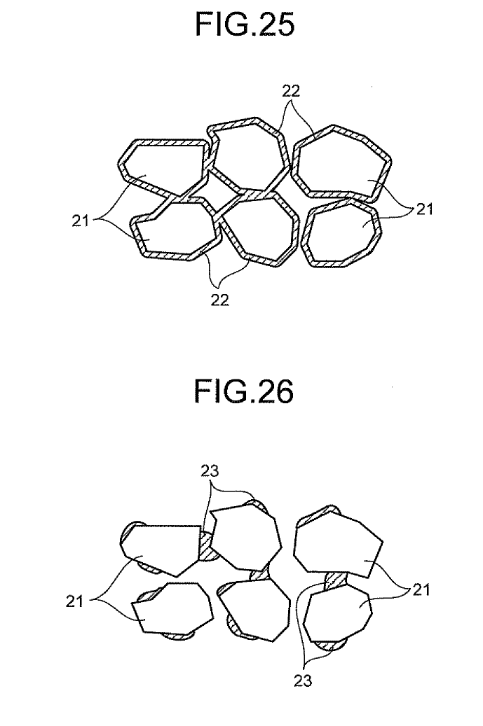

FIG. 25 is a schematic view illustrating the relationship between the soft magnetic material powder and the low-melting-point lubricant agent during the warm press forming. FIG. 26 is a schematic view illustrating the relationship between the soft magnetic material powder and a high-melting-point lubricant agent during the warm press forming according to a comparative example. There are soft magnetic material powders 21, low-melting-point lubricant agents 22, and high-melting-point lubricant agents 23 in FIGS. 25 and 26. The high-melting-point lubricant agent 23 means a lubricant agent generally having a melting point exceeding 170° C., such as beryllium stearate (hereinafter sometimes simply referred to as “St-Be”) having the melting point of 180° C., or lithium stearate (hereinafter sometimes simply referred to as “St-Li”) having the melting point of 220° C.

The soft magnetic material powder 21 is a main component of the rotor cores 10. The soft magnetic material powder 21 includes iron (containing pure iron and iron containing inevitable impurities) as a main composition. Examples of the soft magnetic material powder include only iron, a composition formed by positively adding an element (e.g., Si, P, Co, Ni, Cr, Al, Mo, Mn, Cu, Sn, Zr, B, V, Zn) in a small amount to iron, and permalloy or sendust, and the soft magnetic material powder 21 is composed of only one of them or a combination of two or more of them.

The soft magnetic material powder 21 is composed of iron-base powder that is particles (powder) containing iron as a main composition. The particle diameter of the iron-base powder affects a later-described relative density with respect to the soft magnetic material powder 21 (hereinafter simply referred to as “relative density”) and 1 T (tesla) magnetic field. As the particle diameter is small, the soft magnetic material powder 21 is difficult to be deformed by the pressure during the warm press forming. Therefore, it is not preferable that the particle diameter of the iron-base powder is small. For example, the average particle diameter is preferably about 200 μm. The soft magnetic material powder 21 can be produced by a known powder preparing method such as a gas atomization method, a water atomization method, a rotation atomization method, and a casting grinding method.

The low-melting-point lubricant agent 22 secures fluidity of the soft magnetic material powder 21 during the warm press forming, and functions as an insulating layer interposed between the soft magnetic material powders 21. The low-melting-point lubricant agent 22 is a lubricant agent, among the lubricant agents used for producing the rotor cores 10, having a low melting point and insulating property. The low melting point means the melting point of 50° C. or more and 170° C. or less. Specifically, the low-melting-point lubricant agent 22 is the lubricant agent having the melting point of 50° C. or more and 170° C. or less. Examples of the lubricant agent having the melting point of 50° C. or more and 170° C. or less include zinc oleate having the melting point of 78° C. (hereinafter sometimes simply referred to as “Ore-Zn”), copper stearate having the melting point of 125° C. (hereinafter sometimes simply referred to as “St-Cu”), zinc stearate having the melting point of 127° C. (hereinafter sometimes simply referred to as “St-Zn”), calcium stearate having the melting point of 150° C. (hereinafter sometimes simply referred to as “St-Ca”), aluminum stearate having the melting point of 160° C. (hereinafter sometimes simply referred to as “St-Al”), stearic acid amide having the melting point of 100° C. (hereinafter sometimes simply referred to as “St-amide”), erucamide having the melting point of 80° C. (hereinafter sometimes simply referred to as “El-amide”), or oleic amide having the melting point of 74° C. (hereinafter sometimes simply referred to as “Ore-amide”). The low-melting-point lubricant agent 22 contains only one of them or a combination of two or more of them.

Why the melting point of the low-melting-point lubricant agent 22 is set to be 50° C. or more is based upon the reasons (1) and (2) described below. Specifically, (1) by using the lubricant agent having the melting point of less than 50° C., the lubricant agent might be changed from a later-described solid state to an intermediate state at room temperature, so that when it is added to the soft magnetic material powder 21, it might not be uniformly spread over the soft magnetic material powder. (2) The lubricant agent is easy to be deposited onto the forming mold during the warm press forming, whereby pressure for removal (the pressure for removing the soft magnetic material powder 21 (rotor cores 10) after the warm press forming from the forming mold) is increased, which makes it difficult to form.

The reason why the melting point of the low-melting-point lubricant agent 22 is set to be 170° C. or less is because, by using a lubricant agent having a melting point exceeding 170° C., the lubricant agent cannot sufficiently be changed from the solid state to the intermediate state during the warm press forming as described later, so that the lubricant agent might not fully go into the portion between the soft magnetic material powders 21. A lubricant agent having a low melting point is satisfactory for the low-melting-point lubricant agent, and among the lubricant agents having the melting point of 50° C. or more and 170° C. or less described above, zinc oleate and oleic amide are preferable.

Next, the relationship between the soft magnetic material powder 21 and the lubricant agent during the warm press forming will be described. As described above, the soft magnetic material powder 21 to which the lubricant agent is added is heated to have a temperature higher than the room temperature, and pressed. Accordingly, the lubricant agent added to the soft magnetic material powder 21 changes its form, because the temperature approaches the melting point during the warm press forming. Specifically, the lubricant agent keeps a layered regular crystal structure at the temperature lower than the melting point by −50° C. or less, but at the temperature lower than the melting point by −30° C. or more, it is considered that the layered regular crystal structure is loosed, so that the lubricant agent is changed to be a disk-like shape having a limited size. Specifically, the lubricant agent becomes the intermediate state, which is between the solid phase and a liquid phase, from the solid state, as the temperature rises to the melting point, and then, is finally changed to the liquid state, when the temperature becomes higher than the melting point. It is considered from the above that the fluidity of the lubricant agent is enhanced, whereby the lubricant agent is easy to enter between the soft magnetic material powders 21, as the temperature approaches the melting point.

In the high-melting-point lubricant agent 23 having the melting point higher than that of the low-melting-point lubricant agent 22, the difference between the forming temperature during the warm press forming (the temperature of the forming mold into which the soft magnetic material powder 21 to which the lubricant agent is added is filled) and the melting point is great. Therefore, it is considered that the high-melting-point lubricant agent 23 cannot sufficiently be changed from the solid state to the intermediate state during the warm press forming. Accordingly, as illustrated in FIG. 26, the fluidity of the high-melting-point lubricant agent 23 is not enhanced during the warm press forming of the soft magnetic material powder 21 to which the high-melting-point lubricant agent 23 is added, resulting in that the high-melting-point lubricant agent 23 cannot sufficiently enter between the soft magnetic material powders 21. Therefore, it is considered that the lubricant agent does not sufficiently enclose the iron-base powder. Consequently, it is considered that the slippage between the iron-base particles cannot be increased, so that the sufficient fluidity of the soft magnetic material powder 21 cannot be secured during the warm press forming of the soft magnetic material powder 21 to which the high-melting-point lubricant agent 23 is added.

Accordingly, in the rotor cores 10 containing the soft magnetic material powder 21 and the high-melting-point lubricant agent 23, the deformation of the soft magnetic material powder 21 by the pressure during the warm press forming cannot be accelerated, resulting in that the density cannot sufficiently be increased. Further, it is considered that the high-melting-point lubricant agent 23 having the insulating property cannot sufficiently enclose the iron-base particle, as described above, during the warm press forming of the soft magnetic material powder 21 to which the high-melting-point lubricant agent 23 is added. Therefore, it is considered that, even if the high-melting-point lubricant agent 23 has the insulating property, the high-melting-point lubricant agent 23 cannot sufficiently be interposed between the soft magnetic material powders 21 as the insulating layer. Consequently, the rotor cores 10 containing the soft magnetic material powder 21 and the high-melting-point lubricant agent 23 cannot enhance the insulating property.

On the other hand, in the low-melting-point lubricant agent 22 having the melting point lower than that of the high-melting-point lubricant agent 23, the difference between the forming temperature during the warm press forming and the melting point is small. Therefore, it is considered that the low-melting-point lubricant agent 22 can sufficiently be changed from the solid state to the intermediate state during the warm press forming. In particular, in the low-melting-point lubricant agent 22, the iron-base powders are slipped due to the pressure during the warm press forming so as to reduce the gap between the iron-base powders in the initial stage of the warm press forming, compared with the high-melting-point lubricant agent 23. It is considered that, as the pressure increases afterward, the iron-base powder is deformed, so that before the soft magnetic material powder 21 to which the low-melting-point lubricant agent 22 is added is formed into the optional shape as the rotor cores 10, the low-melting-point lubricant agent 22 can be changed from the solid state to the intermediate state.

Accordingly, as illustrated in FIG. 25, the fluidity of the low-melting-point lubricant agent 22 is enhanced during the warm press forming of the soft magnetic material powder 21 to which the low-melting-point lubricant agent 22 is added, in particular, in the initial stage thereof. Thus, it is considered that the low-melting-point lubricant agent 22 can sufficiently enter between the soft magnetic material powders 21, whereby the low-melting-point lubricant agent 22 can sufficiently enclose the iron-base powder. As a result, it is considered that the slippage between the iron-base particles can be increased, so that the sufficient fluidity of the soft magnetic material powder 21 can be secured during the warm press forming of the soft magnetic material powder 21 to which the low-melting-point lubricant agent 22 is added.

Accordingly, in the rotor cores 10 containing the soft magnetic material powder 21 and the low-melting-point lubricant agent 22, the deformation of the soft magnetic material powder 21 by the pressure during the warm press forming can be accelerated, resulting in that the density of the rotor cores 10 can be made close to the theoretical density, i.e., the true density, of the soft magnetic material powder 21. Therefore, the density can sufficiently be increased. Since the density can sufficiently be increased, a magnetic field of 1 T (here, the magnetic field H [A/m] when the magnetic flux becomes 1 T (B=1 [T]) can sufficiently be reduced. Because of the increased density, the strength of the rotor cores 10 that are the formed product is enhanced, which is preferable for the rotor cores 10 receiving the rotation force. The density of the rotor cores 10 that are the formed product is preferably such that the relative density with respect to the soft magnetic material powder 21 ((the density of the formed product)/(density of the soft magnetic material powder)) is 97.2% or more. Within this range, the sufficient strength as the rotor cores 10 can be obtained.

It is also considered that the low-melting-point lubricant agent 22 having the insulating property can sufficiently enclose the iron-base powder during the warm press forming of the soft magnetic material powder 21 to which the low-melting-point lubricant agent 22 is added as described above, whereby the low-melting-point lubricant agent 22 can sufficiently be interposed between the soft magnetic material powders 21 as the insulating layer. Accordingly, in the rotor cores 10 containing the soft magnetic material powder 21 and the low-melting-point lubricant agent 22, the insulating property can be enhanced, whereby the core loss (the loss of the rotor cores 10) can be reduced.

Before the low-melting-point lubricant agent 22 is added to the soft magnetic material powder 21, the insulating process is performed to the soft magnetic material powder 21. When the soft magnetic material powder 21 is subject to the insulating process, an insulating film enclosing the iron-base powder is formed to enhance the insulating property. However, the insulating film enclosing the iron-base powder has cracks formed thereon because the soft magnetic material powder 21 that has been subject to the insulating process is deformed due to the pressure during the warm press forming, resulting in that the surface of the iron-base powder might be exposed. On the other hand, the low-melting-point lubricant agent 22 can sufficiently enter between the soft magnetic material powders 21 so as to sufficiently enclose the iron-base powder as described above. As a result, even if the insulating film enclosing the iron-base powder is deteriorated, the low-melting-point lubricant agent 22 is sufficiently interposed between the soft magnetic material powders 21 as the insulating layer, with the result that the reduction in the insulating property of the soft magnetic material powder 21, which has been subject to the insulating process, can be prevented.

### Method of Manufacturing Rotor Core

The method of manufacturing the rotor cores 10 will next be described. The rotor cores 10 are manufactured in such a manner that the low-melting-point lubricant agent 22 is added to the soft magnetic material powder 21, and then, the soft magnetic material powder 21 to which the low-melting-point lubricant agent 22 is added is formed by the warm press forming, as described above.

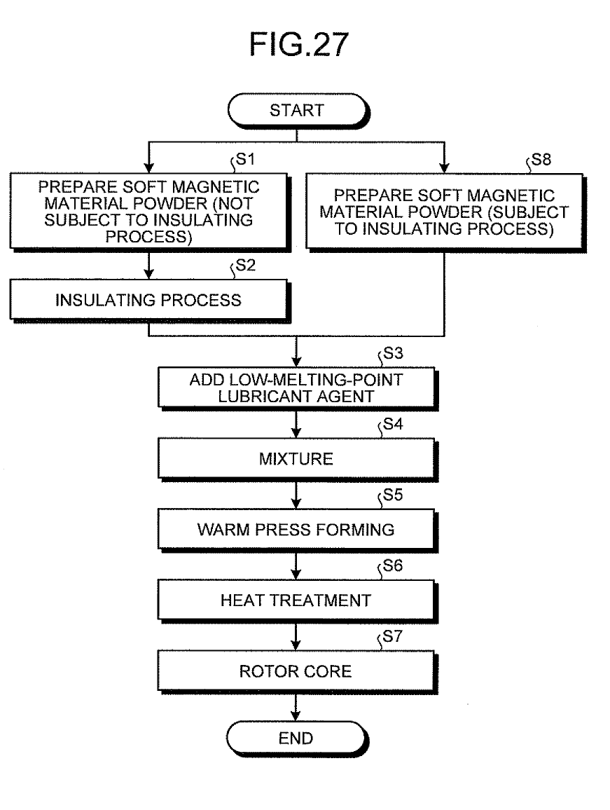

FIG. 27 is a flowchart illustrating the method of manufacturing the rotor core. In the present embodiment, the method includes steps S2 to S6 described below, when the rotor cores 10 (step 57) are manufactured from the soft magnetic material powder 21 (step S1) that has not been subject to the insulating process.

(1) Step S2: a process of performing the insulating process to the soft magnetic material powder 21 that has not yet been subject to the insulating process
(2) Step S3: a process of adding the low-melting-point lubricant agent 22 to the soft magnetic material powder 21 that has already been subject to the insulating process
(3) Step S4: a process of mixing the soft magnetic material powder 21 to which the low-melting-point lubricant agent 22 is added
(4) Step S5: a process of forming the mixed soft magnetic material powder 21 by warm press forming
(5) Step S6: a process of performing a heat treatment to the soft magnetic material powder 21 that has been subject to the warm press forming

The method includes steps S3 to S6 described below, when the rotor cores 10 (step S7) are manufactured from the soft magnetic material powder 21 (step S8) that has already been subject to the insulating process.

(1) Step S3: a process of adding the low-melting-point lubricant agent 22 to the soft magnetic material powder 21 that has already been subject to the insulating process
(2) Step S4: a process of mixing the soft magnetic material powder 21 to which the low-melting-point lubricant agent 22 is added
(3) Step S5: a process of forming the mixed soft magnetic material powder 21 by warm press forming
(4) Step S6: a process of performing a heat treatment to the soft magnetic material powder 21 that has been subject to the warm press forming
The respective steps will be described next in more detail.

In the process (step S2) of performing the insulating process to the soft magnetic material powder 21 that has not yet been subject to the insulating process, the soft magnetic material powder 21 is subject to the insulating process before the low-melting-point lubricant agent 22 is added, so that the insulating film enclosing the iron-base powder is formed. A phosphate treatment is employed, for example, as the insulating process. In the phosphate treatment, the soft magnetic material powder 21 is treated by aqueous solution mainly containing phosphoric acid and phosphate in order to form a phosphate film around the iron-base powder. After the insulating process using the aqueous solution in the phosphate treatment, the soft magnetic material powder 21 is dried before the low-melting-point lubricant agent 22 is added. As the drying method, there is a method of drying the soft magnetic material powder 21 after the phosphate treatment by a hot plate under the environment of 70° C. The insulating film enclosing the iron-base powder is formed during the drying process, whereby the insulating film is interposed between the iron-base powders. Therefore, the insulating property of the rotor cores 10 is enhanced.

In the step (step S3) of adding the low-melting-point lubricant agent 22 to the soft magnetic material powder 21 that has not yet been subject to the insulating process or to the soft magnetic material powder 21 that has been subject to the insulating process, the low-melting-point lubricant agent 22 in a predetermined additive amount is added to the soft magnetic material powder 21. In the present embodiment, a lubricant agent containing at least one of a metal soap with the melting point of 50° C. or more and 170° C. or less and fatty acid amide is used as the low-melting-point lubricant agent 22 added to the soft magnetic material powder 21. Examples of the metal soap with the melting point of 50° C. or more and 170° C. include zinc oleate, copper stearate, zinc stearate, calcium stearate, and aluminum stearate. Examples of the fatty acid amide with the melting point of 50° C. or more and 170° C. or less include stearic acid amide, erucamide, and oleic amide. It is preferable that the metal soap contains at least one of them. By virtue of this, the density can be increased within a wide range of the forming temperature, whereby the increased density and the reduction in a magnetic field of 1 T can sufficiently be attained.

The predetermined additive amount is 0.02% by mass or more and 0.2% by mass or less, and preferably 0.1% by mass or more. The reason why the predetermined additive amount is set to be 0.02% by mass or more is because, when the predetermined additive amount is less than 0.02% by mass, the low-melting-point lubricant agent 22 is too small with respect to the soft magnetic material powder 21, and hence, the low-melting-point lubricant agent 22 might not uniformly be spread over the soft magnetic material powder 21 even if the low-melting-point lubricant agent 22 is added to the soft magnetic material powder 21. The reason why the predetermined additive amount is set to be 0.2% by mass or less is because, when the predetermined additive amount exceeds 0.2% by mass, not only the effect is saturated, but also the increased density and the reduction in a magnetic field of 1 T might not be attained due to the reduction in the content rate of the soft magnetic material powder 21 in the rotor cores 10.

In the step (step S4) of mixing the soft magnetic material powder 21 to which the low-melting-point lubricant agent 22 is added, the mixture of the soft magnetic material powder 21 and the low-melting-point lubricant agent 22 is mixed in order to allow the added low-melting-point lubricant agent 22 to be spread over the soft magnetic material powder 21. For the mixing operation, a mixing machine (e.g., attritor, vibrational mill, ball mill, V mixer, etc.) or a granulating machine (e.g., fluid-bed granulator or tumbling granulator) is used.

In the step (step S5) of performing the warm press forming to the mixed soft magnetic material powder 21, the soft magnetic material powder 21 to which the low-melting-point lubricant agent 22 is added is heated to a temperature higher than the room temperature, and pressed. By virtue of this process, the soft magnetic material powder 21 to which the low-melting-point lubricant agent 22 is added is formed into an optional shape. In the warm press forming, the soft magnetic material powder 21 to which the low-melting-point lubricant agent 22 is added is filled in a forming mold having a cavity of the optional shape. Then, the forming mold is heated to the forming temperature, and the soft magnetic material powder 21 to which the low-melting-point lubricant agent 22 is added is subject to the compression molding by the molding pressure, which is the pressure upon compressing the filled soft magnetic material powder 21.

The forming temperature is 80° C. or more and 200° C. or less, and preferably 130° C. The reason why the forming temperature is set to be 80° C. or more is as described below. Specifically, when the forming temperature is less than 80° C., the forming temperature with respect to the melting point of the low-melting-point lubricant agent 22 is too low, so that the low-melting-point lubricant agent 22 cannot sufficiently be changed from the solid stat to the intermediate state, and from the intermediate state to the liquid state, during the warm press forming, with the result that it cannot efficiently enter between the soft magnetic material powders 21. Further, the increased density and the reduction in a magnetic field of 1 T by the warm press forming cannot be attained.

The reason why the forming temperature is set to be 200° C. or less is as described below. Specifically, when the forming temperature exceeds 200° C., the oxidation of the soft magnetic material powder 21 is accelerated, so that the property of the soft magnetic material powder 21 might be deteriorated, or the manufacturing cost might be increased because the energy required to heat the forming mold is increased.

The molding pressure is 6 ton/cm² or more and 12 ton/cm² or less, and preferably 10 ton/cm². The reason why the molding pressure is set to be 6 ton/cm² or more is as described below. Specifically, when the molding pressure is less than 6 ton/cm², the increased density and the reduction in the 1T magnetic field by the warm press forming cannot be attained. The reason why the molding pressure is set to be 12 ton/cm² or less is as described below. Specifically, when the molding pressure exceeds 12 ton/cm², not only the effect is saturated, but also the manufacturing cost might be increased since the energy required to apply pressure to the soft magnetic material powder 21, to which the low-melting-point lubricant agent 22 is added, is increased. Moreover, when the molding pressure exceeds 12 ton/cm², the durability of the forming mold might be reduced.

In the step (step S6) of performing the heat treatment to the soft magnetic material powder 21 that is formed by the warm press forming, the distortion generated on the iron-base powder due to the pressure applied during the warm press forming is canceled, so as to reduce the core loss (in particular, a hysteresis loss). An annealing treatment may be employed as the heat treatment. The annealing treatment is a treatment in which the soft magnetic material powder 21, which is formed into the optional shape by the warm press forming, is heated in an anneal furnace. The atmosphere in the furnace during the annealing treatment may be atmosphere, hypoxic atmosphere such as argon or nitrogen, hydrogen atmosphere, carbon-dioxide atmosphere, or vacuum. According to the above-mentioned processes, the rotor cores 10 can be integrally formed by using the soft magnetic material powder 21.

In the rotor core described above according to the embodiments, a body, an arm, and a salient pole are integrally formed by using a soft magnetic material powder. For example, the soft magnetic material powder is filled in a forming mold on which a shape of a rotor core is transferred, and the resultant is subject to a press forming, whereby the rotor core made of the soft magnetic material powder and including the body, arm, and salient pole, all of which are integrally formed, can be formed. Since the rotor core can be formed by the press forming as described above, time and labor required to manufacture the rotor core can be reduced, even if the rotor core has a complicated three-dimensional shape. Since the body, the arm, and the salient pole are integrally formed with the use of the soft magnetic material powder, the obtained rotor core has magnetic isotropy, and the path of the magnetic flux is continuous in the rotor core. Thus, the deterioration in the performance of the electric motor can be suppressed.

By virtue of this configuration of the rotor core described above, the volume of the arm can be reduced, whereby the mass of the rotor core can also be reduced. As a result, the electric motor can be started with the reduced electric current, and the inertia of the rotor core can be reduced, whereby the acceleration and deceleration property can be enhanced.

By virtue of the configuration of the rotor core described above, the mass of the rotor core can be reduced, and at least a part of the coil can be arranged at the recessed portion. Consequently, the portion where the coil projects from the rotor core can be reduced, whereby the electric motor can be downsized.

By virtue of the configuration of the rotor core described above, the mass of the rotor core can be reduced, and the whole coil can be arranged at the recessed portion. Consequently, the portion where the coil projects from the rotor core can be reduced, whereby the electric motor can further be downsized.

As described above, the rotor core and the electric motor according to the present invention can reduce time and labor for manufacturing the rotor core, and prevents the deterioration in the performance of the electric motor.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed:

1. A rotor core comprising:
a body made of a soft magnetic material powder, the body being rotatable about a predetermined rotation axis;
plural arms formed integral with the body from the soft magnetic material powder, the arms projecting toward an outside of the body in a diameter direction of the body and being provided with a coil; and
salient poles formed integral with the arms from the soft magnetic material powder, the poles being mounted at the side of the respective arms reverse to the body.

2. The rotor core according to claim 1, wherein
each of the arms has a size in a direction parallel to the rotation axis, the size being smaller than that of each of the salient poles in the direction parallel to the rotation axis.

3. The rotor core according to claim 2, wherein
both ends of the arm in the direction parallel to the rotation axis are recessed from both ends of the salient pole in the direction parallel to the rotation axis.

4. The rotor core according to claim 3, wherein
the both ends of the arm are recessed from the respective ends of the salient pole by the amount corresponding to the thickness or more of the coil provided to the arm.

5. The rotor core according to claim 1, wherein
the arm has a curved face on at least a part thereof.

6. The rotor core according to claim 1, wherein
the arm has a shape of a rectangular column, wherein the corner portion is chamfered.

7. The rotor core according to claim 1, wherein
the body, the arms, and the salient poles contain the soft magnetic material powder and a low-melting-point lubricant agent, wherein a relative density with respect to the soft magnetic material powder is 97.2% or more.

8. The rotor core according to claim 7, wherein
the low-melting-point lubricant agent has a melting point of 50° C. or more and 170° C. or less.

9. The rotor core according to claim 7, wherein the low-melting-point lubricant agent contains at least one of zinc oleate, copper stearate, zinc stearate, calcium stearate, aluminum stearate, stearic acid amide, erucamide, and oleic amide.

10. An electric motor comprising:
a housing;
a stator held at an inner peripheral portion of the housing;
a rotor core including
a body made of a soft magnetic material powder, the body being rotatable about a predetermined rotation axis,
plural arms formed integral with the body from the soft magnetic material powder, the arms projecting toward an outside of the body in a diameter direction of the body and being provided with a coil, and
salient poles formed integral with the arms from the soft magnetic material powder, the poles being mounted at the side of the respective arms reverse to the body, the rotor core being rotatably supported to the housing so as to rotate at an inside of the stator; and
a coil mounted to the respective arms of the rotor core.

11. The electric motor according to claim 10, wherein
both ends of the stator in a direction parallel to the rotation axis and both ends of the salient pole in the direction parallel to the rotation axis are matched.
